(19) United States
(12) Patent Application Publication
(10) Pub. No.: US 2010/0114626 A1
(43) Pub. Date: May 6, 2010

(54) METHOD AND SYSTEM FOR CAR SHARING

(75) Inventors: Sandro Piccinini, Rome (IT); Barbara Febonio, Rome (IT)

Correspondence Address: IBM CORPORATION US;c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/264,785

(22) Filed: Nov. 4, 2008

(51) Int. Cl. G06Q 10/00

(52) U.S. Cl. 705/7

(57) ABSTRACT

The present disclosure is directed to a method for facilitating ride sharing among a plurality of commuters having a common starting location. The method may comprise receiving a leaving status set by a first commuter; retrieving a set of predefined attributes of the first commuter from a repository; sending a travel request to a central manager, the travel request comprising the set of predefined attributes of the first commuter; analyzing the set of predefined attributes to determine a list of potentially matching commuters; broadcasting the travel request to the list of potentially matching commuters; determining a list of confirmed matching commuters based on responses from the list of potentially matching commuters; forming an agreement between the commuters; and setting a new status for the first commuter and each of the list of confirmed matching commuters, the new status indicating completion of ride sharing matching.

### TECHNICAL FIELD

The present disclosure generally relates to the field of computer technology, and more particularly to a method for facilitating ride sharing among a plurality of commuters.

### BACKGROUND

A company may help facilitate ride sharing (carpooling) among its employees. For example, the company may create a local database where employees may register for carpooling from and/or to the office. However, databases that contain static information of the employees may not efficiently facilitate carpooling, as different situations may arise dynamically for various employees. For example, an employee may have an urgent matter to attend to, causing the employee to stay late at the office, while other employees sharing the same ride may not need to work late. Other factors and/or scenarios, such as vacations or illnesses may also need to be considered. For example, an employee may need to attend an appointment at a location different from the location registered in the local database. In such cases, the employee may need to seek other means of transportation.

### SUMMARY

The present disclosure is directed to a method for facilitating ride sharing among a plurality of commuters having a common starting location. The method may comprise receiving a leaving status set by a first commuter; retrieving a set of predefined attributes of the first commuter from a repository; sending a travel request to a central manager, the travel request comprising the set of predefined attributes of the first commuter; analyzing the set of predefined attributes to determine a list of potentially matching commuters; broadcasting the travel request to the list of potentially matching commuters; determining a list of confirmed matching commuters based on responses from the list of potentially matching commuters; forming an agreement between the first commuter and the list of confirmed matching commuters; and setting a new status for the first commuter and each of the list of confirmed matching commuters, the new status indicating completion of ride sharing matching.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a block diagram of an exemplary carpool matching system; and

FIG. 2 is a flow diagram illustrating a method for facilitating ride sharing activities among a plurality of commuters.

### DETAILED DESCRIPTION

Reference will now be made in detail to the subject matter disclosed, which is illustrated in the accompanying drawings.

The present disclosure is directed to a method for facilitating ride sharing (carpooling) among a plurality of commuters having a common starting location (e.g., employees leaving from the same office). Personal attributes of each commuter may be made available to the method, enabling the method to dynamically accommodate carpooling among commuters with compatible ride sharing needs.

In one embodiment, commuters (e.g., employees participating in carpooling) may register their personal attributes in a central repository. Such personal attributes may include, but not limited to, whether they are car owners or passengers, home addresses, standard working hours, flexibility of schedules and alert timeframes (e.g., the commuter may prefer a 5-minute notice prior to departure). Personal attributes collected may allow the method to dynamically match different commuters who are leaving the office around the same time and heading towards the same general direction, effectively reducing/eliminating the need for commuters to manually and/or personally check their schedules with their colleagues.

The method may be implemented as a plug-in to a collaboration system (e.g., an instant messaging application, a calendar application or a personal information management system), in which case the current status of the commuters (e.g., in office, out of office, or leaving office, etc) may be readily available through the collaboration system. Alternatively, the method may be implemented as a stand-alone application allowing the commuters to set their statuses.

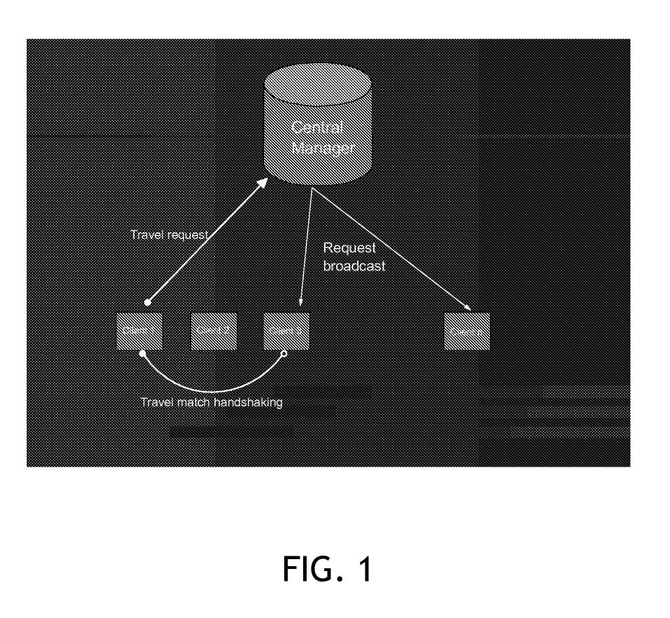

FIG. 1 shows a block diagram of an exemplary carpool matching system. For example, when a first commuter (client 1) realizes that it is close to leaving the office (e.g., 15 minutes before leaving), the first commuter may set his/her status to “leaving” in a collaboration system (e.g., an instant messaging system). Setting the “leaving” status triggers an exchange of information and sends a travel request to a central manager. The travel request may comprise the set of attributes associated with the first commuter, which may include, but not limited to, whether the first commuter is a car owner or a passenger, home/destination address, working hours, flexibility of schedules and alert timeframes.

The central manager analyzes the travel request and determines a list of potentially matching commuters based on the set of attributes specified in the travel request. The determination may be based on compatibilities of the attributes between the first commuter and other commuters of the system. For example, if the first commuter is a car owner, then only the commuters with passenger attributes may be considered as compatible. Other attributes, such as work hours and destinations are also considered to determine the list of potentially matching commuters.

Once the list of potentially matching commuters is determined (e.g., client 3 and client n as illustrated in FIG. 1), the central manager may broadcast the request to the potentially matching commuters. In one embodiment, the potential commuters receiving the request from the central manager may have the option to accept or reject the request. When a particular potential commuter accepts the request (e.g., client 3), information regarding the acceptance may be communicated to the first commuter (client 1) to form an agreement, and this particular potential commuter becomes a confirmed commuter. It is understood that more than one potential commuter may accept the request to become confirmed commuters. Once at least one confirmed commuter is determined, the central manager may set a new status to the first commuter and the confirmed commuters indicting that they have achieved their carpool matching objectives. The central manger may also announce the carpool matching information, for example, as a message to each commuter to indicate the departure time, location, and list of commuters sharing the ride.

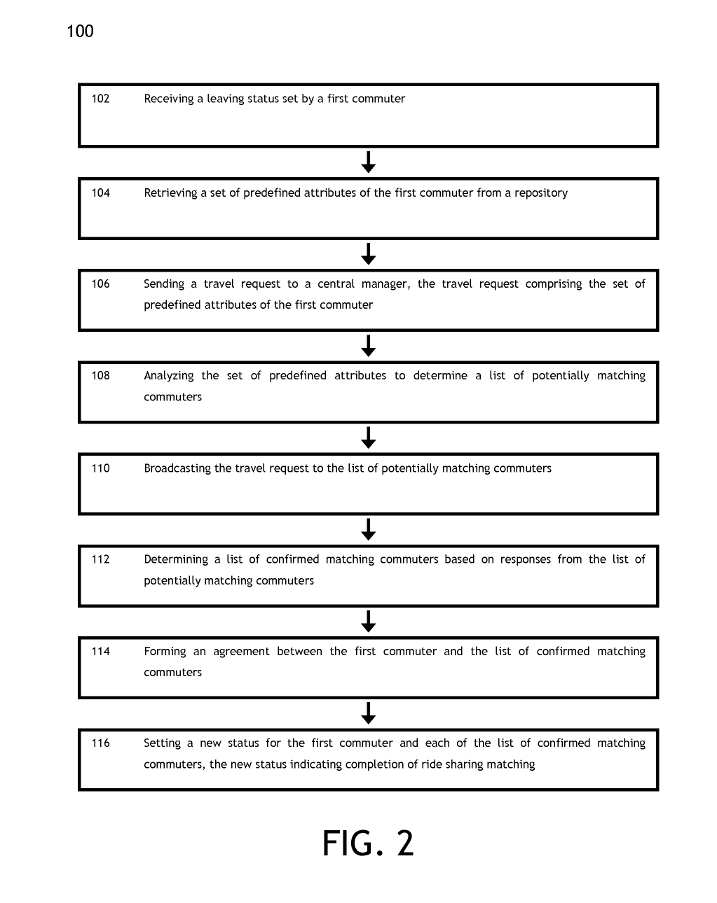

FIG. 2 shows a flow diagram illustrating steps performed by a method 100 in accordance with the present disclosure. The method may be utilized for facilitating ride sharing among a plurality of commuters having a common starting location. Step 102 receives a leaving status set by a first commuter. Step 104 to retrieve a set of predefined attributes of the first commuter from a repository. A travel request comprising the set of predefined attributes of the first commuter is sent to a central manager in step 106. Step 108 analyzes the set of predefined attributes to determine a list of potentially matching commuters. Step 110 broadcasts the travel request to the list of potentially matching commuters. Step 112 determines a list of confirmed matching commuters based on responses from the list of potentially matching commuters. Step 114 forms an agreement between the first commuter and the list of confirmed matching commuters. Step 116 sets a new status indicating completion of ride sharing matching for the first commuter and each of the list of confirmed matching commuters.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for facilitating ride sharing among a plurality of commuters having a common starting location, comprising:
receiving a leaving status set by a first commuter;
retrieving a set of predefined attributes of the first commuter from a repository;
sending a travel request to a central manager, the travel request comprising the set of predefined attributes of the first commuter;
analyzing the set of predefined attributes to determine a list of potentially matching commuters;
broadcasting the travel request to the list of potentially matching commuters;
determining a list of confirmed matching commuters based on responses from the list of potentially matching commuters;
forming an agreement between the first commuter and the list of confirmed matching commuters; and
setting a new status for the first commuter and each of the list of confirmed matching commuters, the new status indicating completion of ride sharing matching.
